(19) United States
(12) Patent Application Publication
(10) Pub. No.: US 2007/0109321 A1
(43) Pub. Date: May 17, 2007

(54) Method for compensating a brightness error of a flat panel display

(75) Inventors: Yi-Sheng Yu, Taoyuan City (TW); Hsu-Pin Kao, Pingjhen City (TW); Yi-Chia Shan, Jhongli City (TW); Kai-Hsiang Hsu, Tucheng City (TW)

Correspondence Address: BACON & THOMAS, PLLC, 625 SLATERS LANE, FOURTH FLOOR, ALEXANDRIA, VA, 22314, US

(73) Assignee: MARKETECH INTERNATIONAL CORP., Taipei City (TW)

(21) Appl. No.: 11/329,177

(22) Filed: Jan. 11, 2006

(30) Foreign Application Priority Data
Nov. 17, 2005 (TW) 094140414

(51) Int. Cl. G09G 5/00

(52) U.S. Cl. 345/616

(57) ABSTRACT

The present invention discloses a method for compensating a brightness error of a flat panel display that compensates the input gray levels under a fixed sustain frequency by an error diffusion compensation circuit. After the gray levels are inputted to the flat panel display, the brightness will be outputted and measured to obtain an actual output brightness, and an ideal output brightness corresponding to the input gray level is calculated according to the linear proportional relation between the input gray level and its ideal output brightness, and then a look up table is created according to the actual output brightness and the ideal output brightness, such that the look up table can be used to overcome the gray level error as well as the error between the actual output brightness and the ideal output brightness of the flat panel display.

### FIELD OF THE INVENTION

The present invention relates to a method for compensating a brightness error of a flat panel display, and more particularly to a method applying to a flat panel display for creating a look up table according to actual output brightness and ideal output brightness and compensating the brightness error of the flat panel display by using the look up table, enabling the flat panel display to output a gray level brightness close to the idea output brightness of the flat panel display and effectively solve the problem having an error between the actual output brightness and the ideal output brightness of the flat panel display.

### BACKGROUND OF THE INVENTION

In general, a plasma display panel (PDP) controls the brightness of each discharge cell of its display panel by the discharge number, and thus a relation of the linear function exists between the discharge number and the brightness as shown in the following formula:
Brightness=k₂×Discharge Number×Brightness Per Discharge

Where, k₂ is a variable representing the number of gray levels of the plasma display panel. For example, if the number of gray levels of the plasma display panel equals to 256, then k2=256. From the above formula, it is known that the more the discharge number of the plasma display panel, the larger is the brightness. However, there is a difference between the number of display gray levels and the actual measured brightness of the plasma display panel due to the following reasons and thus causing unexpectedly poor performance and affecting the quality of displayed images.

(1) Trature Effect & Fluorescent Characteristics

The display gray level of a plasma display panel is comprised of a finite number of sub-fields (SF) and sustain pulse number ratio (which is known as the brightness ratio) as shown in Table 1.

TABLE 1

| | One Display Field = 8 SF | | | | | | | |
|---|---|---|---|---|---|---|---|---|
| | SF1 | SF2 | SF3 | SF4 | SF5 | SF6 | SF7 | SF8 |
| | Sustain Pulse Ratio (Brightness Ratio) | | | | | | | |
| | 1 | 2 | 4 | 8 | 16 | 32 | 64 | 128 |
| Display Output | ◯ indicates SF is ON for this gray level, | | | | | | | |
| Gray Level | and X indicates SF is OFF. | | | | | | | |
| 0 | X | X | X | X | X | X | X | X |
| 1 | ◯ | X | X | X | X | X | X | X |
| 2 | X | ◯ | X | X | X | X | X | X |
| 3 | ◯ | ◯ | X | X | X | X | X | X |
| . . . | . . . | . . . | . . . | . . . | . . . | . . . | . . . | . . . |
| 127 | ◯ | ◯ | ◯ | ◯ | ◯ | ◯ | ◯ | X |
| 128 | X | X | X | X | X | X | X | ◯ |
| 129 | ◯ | X | X | X | X | X | X | ◯ |
| . . . | . . . | . . . | . . . | . . . | . . . | . . . | . . . | . . . |
| 253 | ◯ | X | ◯ | ◯ | ◯ | ◯ | ◯ | ◯ |
| 254 | X | ◯ | ◯ | ◯ | ◯ | ◯ | ◯ | ◯ |
| 255 | ◯ | ◯ | ◯ | ◯ | ◯ | ◯ | ◯ | ◯ |

A flat display panel displaying an 8-bit gray level and having 8 sub-fields for the arrangement is used for illustrating the relation between sustain pulse number ratio of its sub-field and the arrangement of sub-fields of the output gray level. Assumed that the sustain pulse number is linearly proportional to the brightness, the brightness of the fluorescent powder of three color discharge units R(red), G(green), and B(blue) of any pixel having different sustain pulse numbers of the flat panel display is measured in this experiment, and the results are shown in FIG. 1. In the results as shown in FIG. 1, if the three color discharge units are normalized by using the sustain pulse number m as the standard, the results will be the same as those shown in FIG. 2. Obviously, a non-linear proportional relation exists between the brightness and the gray level (which is the sustain pulse number), and the non-linear proportional relation between the brightness and gray level varies as the discharge units of different colors being made of different fluorescent materials. Non-linear phenomenon is caused by Temperature Effect—discharge cause temperature increasing and attenuate fluorescent light emitting. And further, temperature effect of different color fluorescent is different.

(2) Display Ratio & Sustain Frequency

The display ratio (DR, which is an average display gray level of the screen) of the plasma display panel varies with different display screens. For different DR, the sustain pulse number ratio of each sub-field is also different as shown in Table 2. This will cause Sustain Frequency (fs) and pulse number different of the same gray level in different display screens and affect the proportional of gray level and brightness.

TABLE 2

| | | | | | | | | | Total | |
|---|---|---|---|---|---|---|---|---|---|---|
| Display | | | | | | | | | Pulse | |
| Ratio | SF1 | SF2 | SF3 | SF4 | SF5 | SF6 | SF7 | SF8 | Number | fs (kHz) |
| 0 | 0 | 0 | 0 | 0 | 0 | 0 | 0 | 0 | 0 | 0 |
| 1% | 3 | 7 | 14 | 28 | 56 | 112 | 224 | 448 | 892 | 53.52 |
| 2% | 3 | 7 | 14 | 28 | 56 | 112 | 224 | 448 | 892 | 53.52 |
| . . . | . . . | . . . | . . . | . . . | . . . | . . . | . . . | . . . | . . . | . . . |
| 10% | 3 | 6 | 12 | 25 | 51 | 102 | 204 | 409 | 812 | 48.72 |
| . . . | . . . | . . . | . . . | . . . | . . . | . . . | . . . | . . . | . . . | . . . |
| 20% | 2 | 5 | 11 | 22 | 44 | 89 | 179 | 358 | 710 | 42.6 |
| . . . | . . . | . . . | . . . | . . . | . . . | . . . | . . . | . . . | . . . | . . . |
| 40% | 2 | 4 | 8 | 16 | 32 | 64 | 128 | 256 | 510 | 30.6 |
| . . . | . . . | . . . | . . . | . . . | . . . | . . . | . . . | . . . | . . . | . . . |
| 80% | 1 | 2 | 4 | 8 | 16 | 32 | 64 | 128 | 255 | 15.3 |
| . . . | . . . | . . . | . . . | . . . | . . . | . . . | . . . | . . . | . . . | . . . |
| 100% | 1 | 1 | 2 | 4 | 8 | 20 | 45 | 80 | 161 | 9.66 |

From above, the correct gray level output of the display device such as a plasma display panel using the pulse number modulation to produce the gray levels will be affected by the discharge characteristic, the light emitting characteristic of the fluorescent object, the temperature and brightness attenuation effect, and the sustain frequency (fs), etc, and thus we cannot be guaranteed to obtain an accurate brightness output. To overcome this problem, U.S. Pat. No. 5,943,032 issued to Fujitsu proposed a method of adjusting the sustain pulse number, and U.S. Pat. No. 6,088,009 issued to LG proposed a method of adding a pseudo pulse for changing the relation between the gray level and the brightness, such that the gray level is linearly proportional to the brightness. However, the actual effects of these patented technologies are very limited and cannot surely and effectively overcome the foregoing problems.

In a digital video processing, it is common to increase the bit number of the image processing appropriately to improve the processing precision, but a general display can show an integral number of the gray levels only. Referring to FIG. 3 for the traditional method that eliminates the profile contouring phenomenon of the plasma display panel at its low gray level range due to insufficient number of the gray levels for image signals, the image signal of the plasma display panel is generally compensated by an error diffusion circuit 20 with an error diffusion method, so as to compensate the error caused by the difference between the processing bit number and the outputted bit number. However, such method only takes the gray level error into consideration without considering the error between the actual brightness and the ideal brightness of the flat panel display and still cannot surely and effectively overcome the foregoing problem.

Therefore, finding a way of compensating the inputted image signal of a flat panel display for the brightness error occurred at different sustain frequencies of the flat panel display in a digital video signal processing to overcome the gray level error as well as the error between the actual output brightness and the ideal brightness of the flat panel display becomes the subject that demands immediate attentions and solutions, in hope of achieving the object of obtaining an actual brightness very close to the ideal brightness.

### SUMMARY OF THE INVENTION

In view of the shortcomings of the prior art that cannot surely and effectively overcome the error between the actual output brightness and the ideal brightness of a flat panel display, the inventor of the present invention based on years of experience to conduct extensive researches and experiments, and finally invented a method for compensating a brightness error of a flat panel display in accordance with the present invention.

Therefore, it is a primary objective of the present invention to obtain actual output brightness Yₘₑₐ (fs, Gray) by measuring output brightness after a series of gray level signals (Gray) being inputted to a flat panel display under a fixed sustain frequency (fs), and calculate the ideal brightness Y_{ideal} (fs, Gray) corresponding to the input gray level according to the linear proportional relation between the input gray level and the ideal output brightness, and create a look up table according to the actual output brightness Yₘₑₐ (fs, Gray) and the ideal output brightness Y_{ideal} (fs, Gray). The look up table includes a series of converted gray levels (Gray′) and the actual output brightness Yₘₑₐ (fs, Gray′) corresponding to each converted gray level (Gray′), and the actual output brightness Yₘₑₐ (fs, Gray′) corresponding to each converted gray level is very close to the ideal output brightness Y_{ideal} (fs, Gray) of each input gray level. Thus, when a gray level is going to be inputted to the flat panel display, a corresponding converted gray level will be looked up from the look up table first, and the converted gray level will then be inputted to the flat panel display, so that the flat panel display can output a gray level brightness close to the idea output brightness Y_{ideal} (fs, Gray) of the flat panel display to effectively solve the problem having an error between the actual output brightness and the ideal output brightness of the flat panel display.

Another objective of the present invention is to use an error diffusion method to compensate the input gray levels under a fixed sustain frequency by an error diffusion compensation circuit. After the compensated input gray levels are inputted to the flat panel display, the brightness will be outputted and measured to obtain an actual output brightness Yₘₑₐ (fs, Gray) and the ideal output brightness Y_{ideal} (fs, Gray) corresponding to the input gray level is calculated according to the linear proportional relation between the input gray level and its ideal output brightness, and then the look up table is created according to the actual output brightness Yₘₑₐ (fs Gray) and the ideal output brightness Y_{ideal} (fs, Gray), such that the look up table can overcome the gray level error as well as the error between the actual output brightness and the ideal output brightness of the flat panel display.

A further objective of the present invention is to create a brightness to gray look up Table (Brightness to Gray LUT) according to the actual output brightness Yₘₑₐ (fs, Gray) and the ideal output brightness Y_{ideal} (fs, Gray), and the look up table includes a first converted gray level LUT_{BG} (fs, Gray), and each actual output brightness Yₘₑₐ (fs, Gray′) corresponds to the first converted gray level LUT_{BG} (fs, Gray). Each actual output brightness Yₘₑₐ (fs, Gray′) corresponding to the first converted gray level LUT_{BG} (fs, Gray) is a brightness closest to the ideal output brightness Y_{ideal} (fs, Gray) of each input gray level, so as to effectively overcome the gray level error of the flat panel display as well as effectively overcome the error between the actual output brightness and the ideal output brightness of the flat panel display.

A further objective of the present invention is to use the actual output brightness Yₘₑₐ (fs, Gray) as the base and the following formula to interpolate and calculate the brightness error compensation value LUT_{BE} (fs, Gray) required by the ideal output brightness Y_{ideal} (fs, Gray), assumed that the frequency fs=f and the gray level Gray=g:

$$if {Y}_{ideal} ( f , g ) \geq {Y}_{mea .} ( f , g )$$

$${LUT}_{BE} ( f , g ) = \frac{{Y}_{ideal} ( f , g ) - {Y}_{mea .} ( f , g )}{{Y}_{mea .} ( f , g + 1 ) - {Y}_{mea .} ( f , g )}$$

$$if {Y}_{ideal} ( f , g ) < {Y}_{mea .} ( f , g )$$

$${LUT}_{BE} ( f , g ) = \frac{{Y}_{ideal} ( f , g ) - {Y}_{mea .} ( f , g )}{{Y}_{mea .} ( f , g ) - {Y}_{mea .} ( f , g - 1 )}$$

A brightness error look up table (Brightness Error LUT) is created accordingly. Thus, when a gray level is going to be inputted to the flat panel display, a brightness error compensation value LUT_{BE} (fs, Gray) is looked up from the look up table first, and the gray level plus the brightness error compensation value LUT_{BE} (fs, Gray) is obtained as a second converted gray level value. After the second converted gray level value is inputted to the flat panel display, such that the flat panel display can output a brightness Y_{BE} (fs, Gray) close to the ideal output brightness to overcome the gray level error as well as the error between the actual output brightness and the ideal output brightness of the flat panel display. Another further objective of the present invention is to create both panel brightness gray level look up table and brightness error look up table according to the actual output brightness Yₘₑₐ (fs, Gray) and the ideal output brightness Y_{ideal} (fs, Gray), such that the input gray level is able to utilize the first converted gray level value and the second converted gray level value and then inputted to the flat panel display, enabling the flat panel display to output the output brightness close to the ideal output brightness.

The above and other objects, features and advantages of the present invention will become apparent from the following detailed description taken with the accompanying drawings.

### BRIEF DESCRIPTION OF THE DRAWINGS

FIG. 1 is a curve showing a proportional relation between a normalized discharge number of the three color discharge units in each pixel and the normalized brightness (corresponding to maximum brightness of all color) of a prior art plasma display panel;

FIG. 2 is a curve showing a proportional relation between a normalized discharge number of the three color discharge units in each pixel and the normalized brightness (corresponding to the brightness of m pulse number of each color) of a prior art plasma display panel;

FIG. 3 is a flow chart of an input gray level processed by an error diffusion method according to a prior art plasma display panel;

FIG. 4 is a flow chart of an input gray level being corrected according to a first preferred embodiment of the present invention;

FIG. 5 is a flow chart of an input gray level being corrected according to a second preferred embodiment of the present invention;

FIG. 6 is a flow chart of an input gray level being corrected according to a third preferred embodiment of the present invention;

FIG. 7 is a curve showing a relation between the brightness of the input gray level and the compensated input gray level according to the first and second preferred embodiments of the present invention; and

FIG. 8 is a curve showing a relation between the brightness errors of the input gray level and the compensated input gray level according to the first and second preferred embodiments of the present invention.

### DETAILED DESCRIPTION OF THE PREFERRED EMBODIMENTS

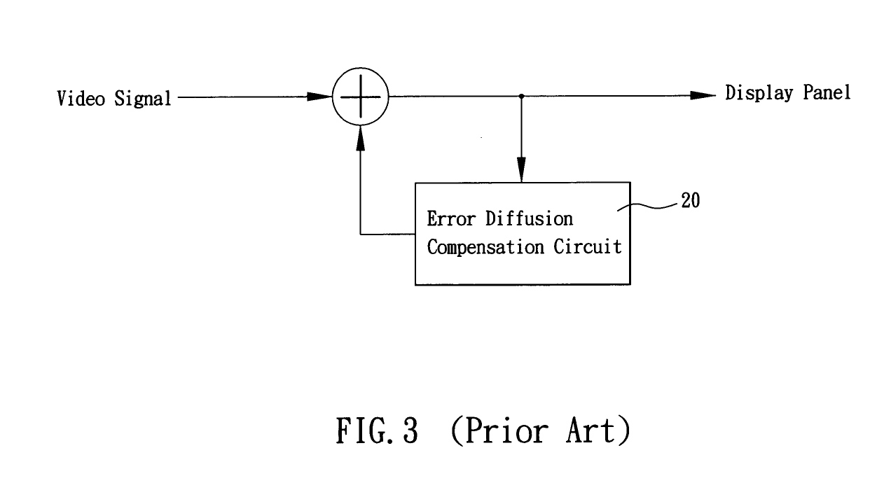

Since most of the present flat panel displays are 8-bit gray level displays, the actual image processing is carried out by a processing over 8 bits to improve the accuracy of the image processing. If a high bit (i.e. the integral gray level) of the computation result is used directly for the output, the computational accuracy will be sacrificed and the image processing effect will be affected adversely. For the low bit gray level (i.e. the decimal gray level) that cannot be outputted directly for the display, an error diffusion or a spacial error diffusion method is used for diffusing the low bit gray level to the peripheral pixels as shown in FIG. 3, so as to solve the problem produced by a low output accuracy. Since the error diffusion method has been used in many prior arts, including U.S. Pat. No. 6,774,873, and thus the details of the error diffusion method will not be described here.

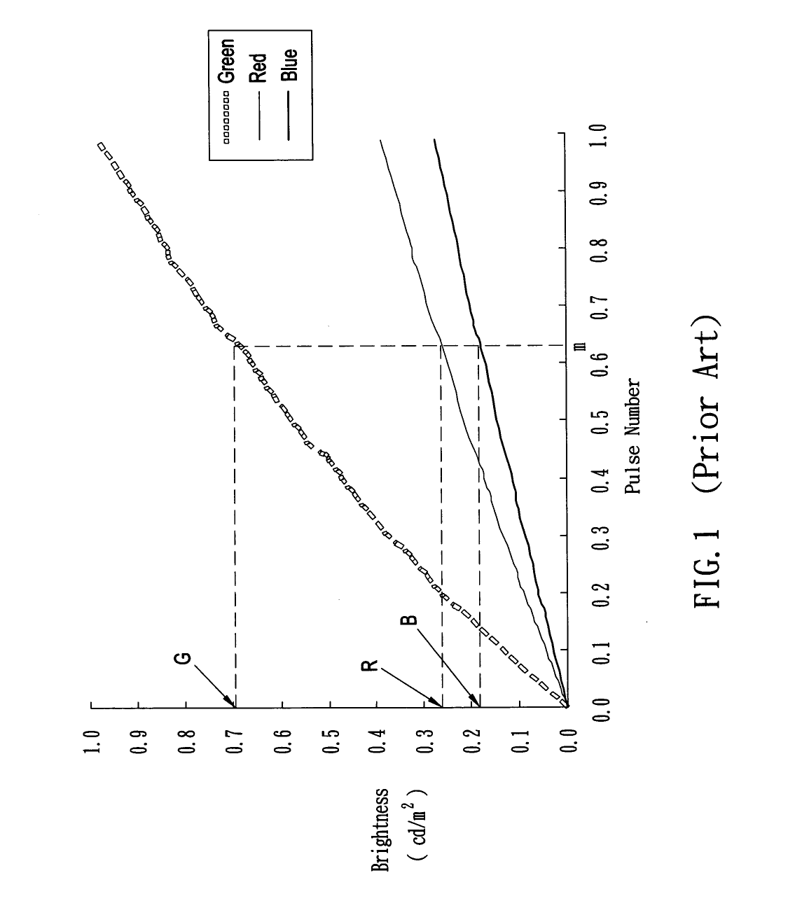

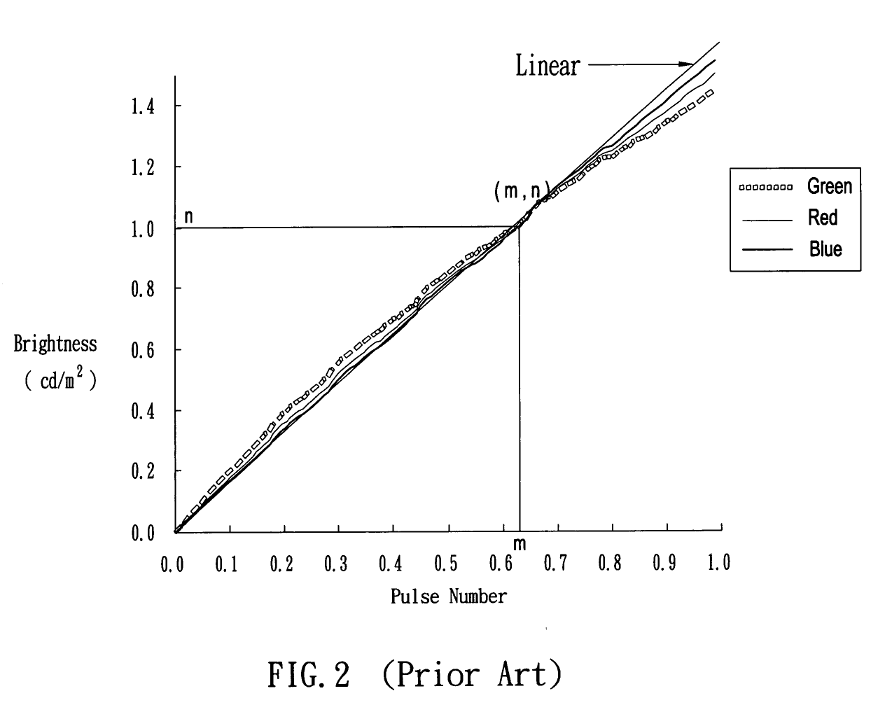

Referring to FIG. 1, FIG. 2, Table 1 and Table 2 for the relation between the brightness and the sustain frequency (fs) of the flat panel display, the relation does not show a linear proportion due to the characteristics of different fluorescent materials in the discharge unit. In the first preferred embodiment of the present invention, a series of gray level signals are inputted to each discharge unit of the flat panel display under the fixed sustain frequency (fs) before the brightness of the flat panel display is compensated. In FIG. 3, the input gray level is compensated by an error diffusion compensation circuit 20 by using an error diffusion method, After the compensated input gray level is inputted to the flat panel display, the output brightness is measured to obtain an actual output brightness Yₘₑₐ (fs Gray). The ideal output brightness Y_{ideal} (fs, Gray) corresponding to the input gray levels is calculated according to the linear proportional relation between the gray level and the ideal brightness. Therefore, the first preferred embodiment creates a brightness to gray look up table (Brightness to Gray LUT) according to the actual output brightness Yₘₑₐ (fs, Gray) and the ideal output brightness Y_{ideal} (fs, Gray), and the look up table includes a first converted gray level LUT_{BG} (fs, Gray), and the first converted gray level LUT_{BG} (fs, Gray) can map an input gray to the corresponding gray level which is the closest to the ideal output brightness Y_{BG} (fs, Gray), and the brightness error E_{BG} between the output brightness Y_{BG} (fs, Gray) and the ideal output brightness Y_{ideal} (fs, Gray) can be calculated by the following formula:
E_{BG}(fs, Gray)=Y_{ideal}(fs, Gray)−Y_{BG}(fs, Gray)

To make the design concept of the first preferred embodiment clearer and more specific, the present invention specially uses the gray level values of 0˜20 as the series of input gray levels as shown in the data of Table 3 to illustrate the method and process of creating the brightness to gray LUT. In FIG. 3, when a gray level value of an input signal is equal to 4 and compensated by the error diffusion compensation circuit 20 and inputted to the flat panel display, then the actual measured output brightness Yₘₑₐ (fs, 4)=2.18 and the ideal output brightness Y_{idea} (fs, 4)=3.00. Therefore, the error E_{ORI} (fs, 4) between the ideal output brightness Y_{ideal} (fs, 4) and the actual output brightness Yₘₑₐ (fs, 4) is up to 0.82. After that, when a gray level value of a signal equal to 5 is inputted, as referring to Table 3, the actual measured output brightness Yₘₑₐ (fs, 5)=3.26, and the error is just −0.26 by comparing Yₘₑₐ (fs, 5) with the ideal output brightness Y_{ideal} (fs, 4)=3.00. In other words, Yₘₑₐ (fs, 5) is closer than Yₘₑₐ (fs, 4) to the corresponding ideal output brightness Y_{ideal} (fs, 4). When the present invention creates the brightness to gray look up table, the gray level 5 is used as the first converted gray level LUT_{BG} (fs, 4) for the input gray level 4 to fill up the look up table, and the first converted gray level LUT_{BG} (fs, 4) is inputted to the flat panel display to provide the output value of the measured brightness Y_{BG} (fs, 4)=Yₘₑₐ (fs, 5)=3.26. Similarly, in FIG. 3, after a gray level value 5 of an input signal is inputted to the flat panel display, the actual measured output brightness value Yₘₑₐ (fs, 5)=3.26, and the ideal output brightness value Y_{ideal} (fs, 5)=3.75. Therefore, the error E_{ORI} (fs, 5) between the ideal output brightness Y_{ideal} (fs, 5) and the actual output brightness Yₘₑₐ (fs, 5) is 0.49. After that, when a signal with a gray level value 6 is inputted, as referring to Table 3, the actual measured output brightness value Yₘₑₐ (fs, 6)=3.83, the error is just −0.08 by comparing Yₘₑₐ (fs, 6) with the corresponding ideal output brightness Y_{ideal} (fs, 5)=3.75. In other words, Yₘₑₐ (fs, 6) is closer than Yₘₑₐ (fs, 5) to the corresponding ideal output brightness Y_{ideal} (fs, 5). Therefore, the gray level 6 is used as the first converted gray level LUT_{BG} (fs, 5) for the input gray level 5 to fill up the look up table, and the first converted gray level LUT_{BG} (fs, 5) is inputted to the flat panel display to produce the output value of the actual brightness Y_{BG} (fs, 5)=Yₘₑₐ (fs, 6)=3.83, and so on. The brightness to gray look up table can be created successfully by the corresponding first converted gray level LUT_{BG} (fs, Gray) for each input gray and the brightness closest to the ideal output brightness Y_{BG} (fs, Gray).

TABLE 3

| Input | Ideal | Original | | Brightness to Gray LUT | | |
|---|---|---|---|---|---|---|
| Gray | Y_{ideal} | Yₘₑₐ | E_{ORI} | LUT_{BG} | Y_{BG} | E_{BG} |
| (g) | (f, g) | (f, g) | (f, g) | (f, g) | (f, g) | (f, g) |
| (unit) | (cd/m²) | (cd/m²) | (cd/m²) | (gray) | (cd/m²) | (cd/m²) |
| 0 | 0.00 | 0.00 | 0.00 | 0 | 0.00 | 0.00 |
| 1 | 0.75 | 0.00 | 0.75 | 2 | 0.57 | 0.18 |
| 2 | 1.50 | 0.57 | 0.93 | 3 | 1.62 | −0.12 |
| 3 | 2.25 | 1.62 | 0.63 | 4 | 2.18 | 0.07 |
| 4 | 3.00 | 2.18 | 0.82 | 5 | 3.26 | −0.26 |
| 5 | 3.75 | 3.26 | 0.49 | 6 | 3.83 | −0.08 |
| 6 | 4.50 | 3.83 | 0.67 | 7 | 4.85 | −0.35 |
| 7 | 5.25 | 4.85 | 0.40 | 8 | 5.42 | −0.17 |
| 8 | 6.00 | 5.42 | 0.58 | 9 | 6.47 | −0.47 |
| 9 | 6.75 | 6.47 | 0.28 | 9 | 6.47 | 0.28 |
| 10 | 7.50 | 7.15 | 0.35 | 10 | 7.15 | 0.35 |
| 11 | 8.25 | 7.93 | 0.32 | 12 | 8.47 | −0.22 |
| 12 | 9.00 | 8.47 | 0.53 | 13 | 9.01 | −0.01 |
| 13 | 9.75 | 9.01 | 0.74 | 14 | 9.57 | 0.18 |
| 14 | 10.50 | 9.57 | 0.93 | 15 | 10.57 | −0.07 |
| 15 | 11.25 | 10.57 | 0.68 | 16 | 11.14 | 0.11 |
| 16 | 12.00 | 11.14 | 0.86 | 17 | 11.92 | 0.08 |
| 17 | 12.75 | 11.92 | 0.83 | 18 | 12.94 | −0.19 |
| 18 | 13.50 | 12.94 | 0.56 | 18 | 12.94 | 0.56 |
| 19 | 14.25 | 14.43 | −0.18 | 19 | 14.43 | −0.18 |
| 20 | 15.00 | 14.97 | 0.03 | 20 | 14.97 | 0.03 |

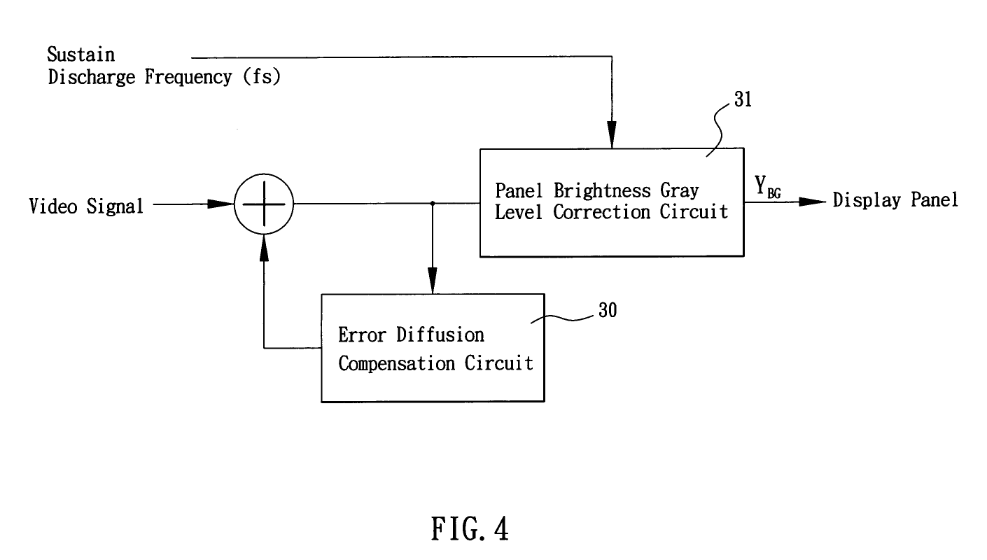

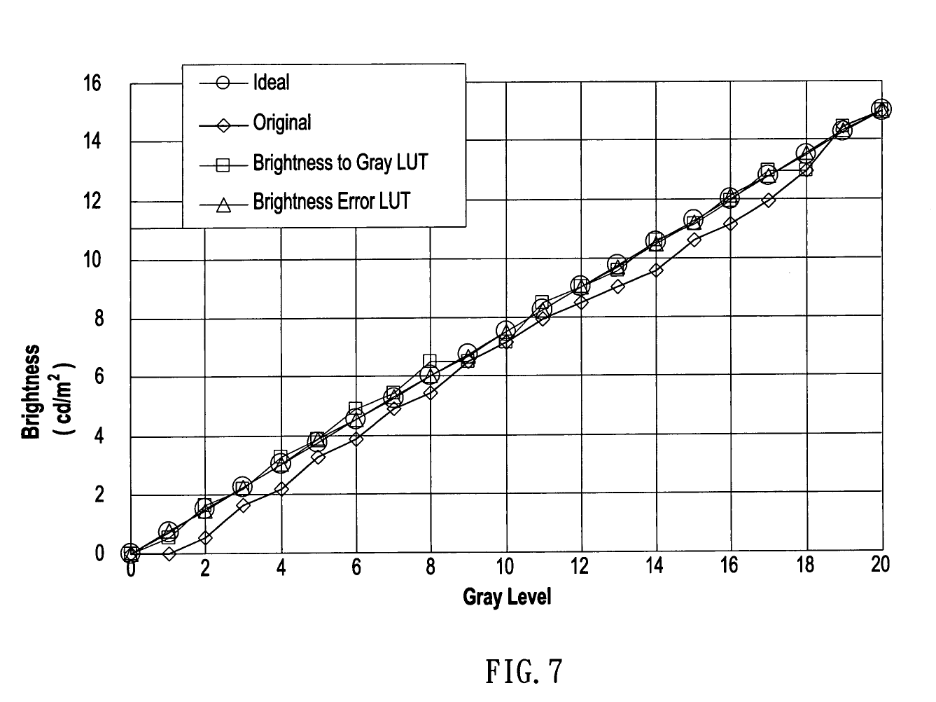

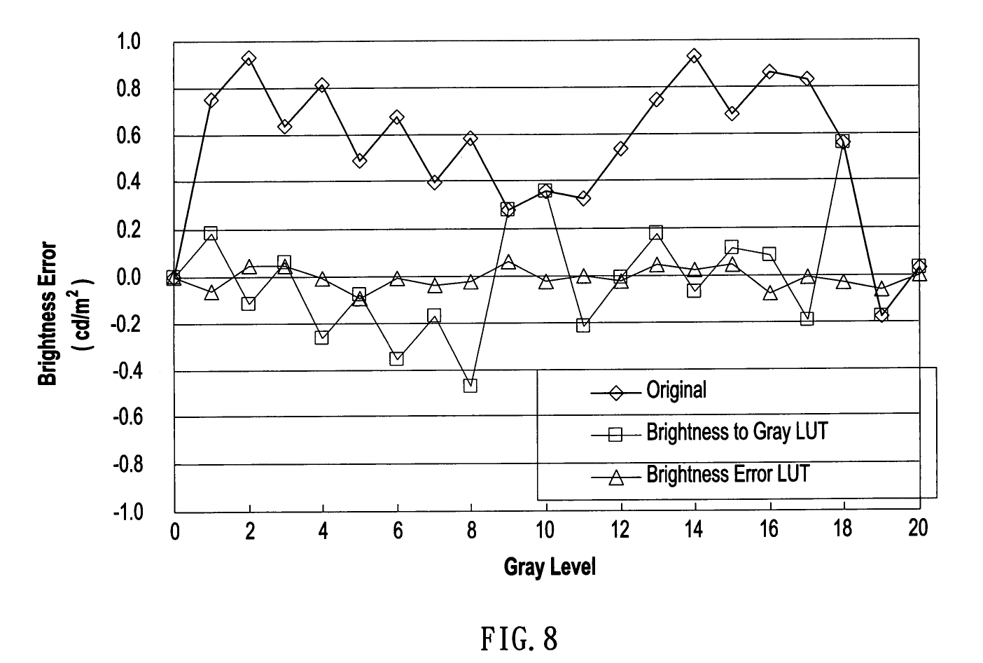

the actual output brightness and the ideal output brightness of the flat panel display can be obtained by the curves showing the relation between the measured brightness value and the brightness error before and after compensation as shown in FIGS. 7 and 8. Obviously, the output brightness error E_{BG} (fs, Gray) is much smaller than the original error E_{ORI} (fs, Gray) and thus the gray level and brightness error of the flat panel display can be corrected and compensated to give an excellent effect. In the first preferred embodiment, the brightness to gray look up table is used to produce a panel brightness gray level correction circuit 31 to operate together with a prior art error diffusion compensation circuit 30 as shown in FIG. 4. After the error diffusion compensation circuit 30 compensates the input gray level by the error diffusion method, the panel brightness gray level correction circuit 31 corrects the signals inputted to the flat panel display, so as to overcome the gray level error as well as the error between the actual output brightness and the ideal output brightness of the flat panel display.

In the second preferred embodiment of the present invention, a frequency brightness error compensation function is added to correct the error of the output brightness of the flat panel display caused by the sustain frequency. The method is to input a series of gray level signals to each discharge unit of the flat panel display at a fixed sustain frequency. Again referring to FIG. 3, after the gray levels are inputted, an error diffusion compensation circuit 20 will compensate the gray levels by using an error diffusion method, and the compensated gray level will be inputted to the flat panel display, and the output brightness will be measured to obtain the actual output brightness Yₘₑₐ (fs, Gray). The ideal output brightness Y_{ideal} (fs, Gray) corresponding to the input gray level value is calculated according to the ideal linear proportional relation between the gray level and the brightness. Therefore, the invention uses the actual output brightness Yₘₑₐ (fs, Gray) as a base to interpolate and calculate the brightness error compensation value LUT_{BE} (fs, Gray) required for the ideal output brightness Y_{ideal} (fs, Gray), if the frequency at the time is fs=f, and the gray level value Gray=g.

$$if {Y}_{ideal} ( f , g ) \geq {Y}_{mea .} ( f , g )$$

$${LUT}_{BE} ( f , g ) = \frac{{Y}_{ideal} ( f , g ) - {Y}_{mea .} ( f , g )}{{Y}_{mea .} ( f , g + 1 ) - {Y}_{mea .} ( f , g )}$$

$$if {Y}_{ideal} ( f , g ) < {Y}_{mea .} ( f , g )$$

$${LUT}_{BE} ( f , g ) = \frac{{Y}_{ideal} ( f , g ) - {Y}_{mea .} ( f , g )}{{Y}_{mea .} ( f , g ) - {Y}_{mea .} ( f , g - 1 )}$$

After a series of gray level signals are inputted to the flat panel display at different sustain frequencies, the above formula is used to calculate the brightness error compensation value LUT_{BE} (fs, Gray) of each input gray level at different frequencies, and a brightness error look up table (Brightness Error LUT) is created as shown in Table 4. Thus, after an input gray level is used to look up a corresponding brightness error compensation value in the brightness error look up table, the original input gray level plus the brightness error compensation value are used to obtain a second converted gray level value. After the second converted gray level value is inputted to the flat panel display, the flat panel display outputs a brightness close to the ideal output brightness Y_{BE} (fs, Gray). The brightness error E_{BE} between the actual output brightness and the ideal output brightness Y_{ideal} (fs, Gray) is given by the following formula:
E_{BE}(fs, Gray)=Y_{ideal}(fs, Gray)−Y_{BE}(fs, Gray)

TABLE 4

| Input | Ideal | Original | | Brightness Error LUT | | |
|---|---|---|---|---|---|---|
| Gray | Y_{ideal} | Yₘₑₐ | E_{ORI} | LUT_{BE} | Y_{BE} | E_{BE} |
| (g) | (f, g) | (f, g) | (f, g) | (f, g) | (f, g) | (f, g) |
| (unit) | (cd/m²) | (cd/m²) | (cd/m²) | (gray) | (cd/m²) | (cd/m²) |
| 0 | 0.00 | 0.00 | 0.00 | 0.00 | 0.00 | 0.00 |
| 1 | 0.75 | 0.00 | 0.75 | 1.32 | 0.81 | −0.06 |
| 2 | 1.50 | 0.57 | 0.93 | 0.89 | 1.45 | 0.05 |
| 3 | 2.25 | 1.62 | 0.63 | 1.12 | 2.20 | 0.05 |
| 4 | 3.00 | 2.18 | 0.82 | 0.76 | 3.01 | −0.01 |
| 5 | 3.75 | 3.26 | 0.49 | 0.86 | 3.84 | −0.09 |
| 6 | 4.50 | 3.83 | 0.67 | 0.65 | 4.51 | −0.01 |
| 7 | 5.25 | 4.85 | 0.40 | 0.70 | 5.29 | −0.04 |
| 8 | 6.00 | 5.42 | 0.58 | 0.55 | 6.02 | −0.02 |
| 9 | 6.75 | 6.47 | 0.28 | 0.41 | 6.69 | 0.06 |
| 10 | 7.50 | 7.15 | 0.35 | 0.45 | 7.52 | −0.02 |
| 11 | 8.25 | 7.93 | 0.32 | 0.60 | 8.25 | 0.00 |
| 12 | 9.00 | 8.47 | 0.53 | 0.99 | 9.02 | −0.02 |
| 13 | 9.75 | 9.01 | 0.74 | 1.31 | 9.70 | 0.05 |
| 14 | 10.50 | 9.57 | 0.93 | 0.93 | 10.48 | 0.02 |
| 15 | 11.25 | 10.57 | 0.68 | 1.20 | 11.20 | 0.05 |
| 16 | 12.00 | 11.14 | 0.86 | 1.10 | 12.08 | −0.08 |
| 17 | 12.75 | 11.92 | 0.83 | 0.81 | 12.76 | −0.01 |
| 18 | 13.50 | 12.94 | 0.56 | 0.38 | 13.53 | −0.03 |
| 19 | 14.25 | 14.43 | −0.18 | −0.12 | 14.31 | −0.06 |
| 20 | 15.00 | 15.00 | 0.03 | 0.00 | 15.00 | 0.00 |

To make the design concept of the second preferred embodiment clearer and more specific, the present invention specially uses a series of gray level value 0˜20 for the input gray levels to operate with the data as shown in Table 4 to illustrate the method and process of creating the brightness error look up table. As referring to FIG. 3 again, when the gray level values 4 and 5 of the input signals have been processed by the error diffusion compensation circuit 20 through an error diffusion method for compensating the errors thereof and are inputted to the flat panel display, the actual measured brightness values Yₘₑₐ (fs, 4) and Yₘₑₐ (fs, 5) are 2.18 and 3.26, and the ideal output brightness values Y_{ideal} (fs, 4) and Y_{ideal} (fs, 5) are 3.00 and 3.75 respectively. Since Yₘₑₐ (fs, 4)<Y_{ideal} (fs, 4), therefore the foregoing brightness error compensation formula is used to obtain the brightness error compensation value LUT_{BE} (fs, 4)=0.76. Now, the original input gray level 4 plus the brightness error value LUT_{BE} (fs, 4) are used to produce a second converted gray level. After the second converted gray levels are inputted to the flat panel display, the actual measured output brightness Y_{BE} (fs, 4)=3.01 of the flat panel display is measured and the E_{BE} (fs, 4) between the actual output brightness Y_{BE} (fs, 4)=3.01 and the ideal output brightness Y_{ideal} (fs, 4)=3.00 is just −0.01, which is closer to the ideal output brightness Y_{ideal} (fs, 4), and so on. In the second preferred embodiment, the brightness error compensation value LUT_{BE} (fs, Gray) corresponding to each input gray level and the brightness closest to the ideal output brightness Y_{BE} (fs, Gray) are found for creating the brightness error look up table successfully.

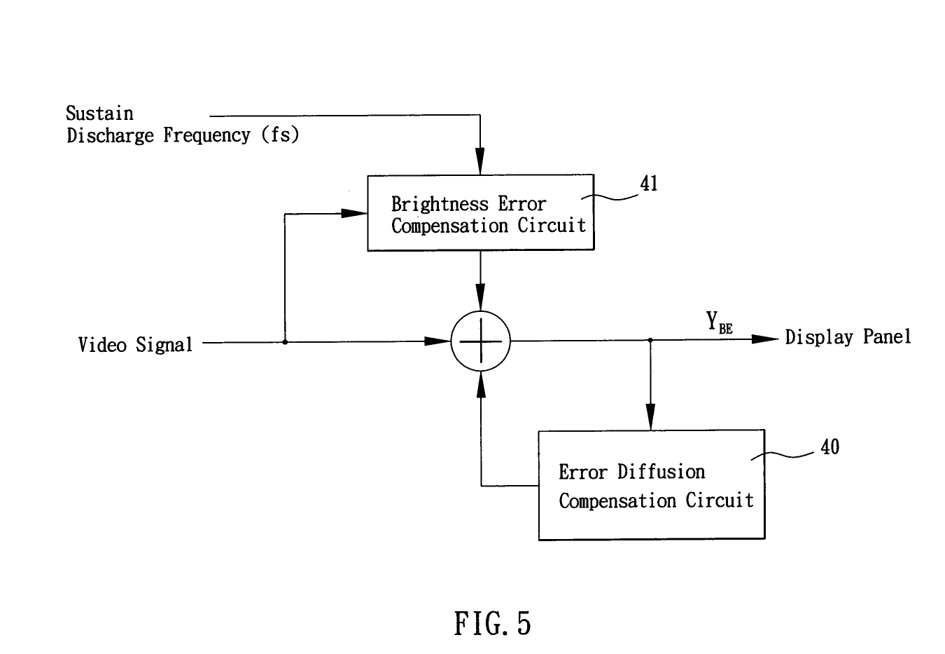

From Table 4, after the gray levels inputted to the flat panel display have been corrected by the brightness error look up table, in view of curves shown in FIGS. 7 and 8 for showing the relation between the brightness values and the brightness error before and after compensation, the error E_{BE} (fs, Gray) between the actual output brightness and the ideal output brightness of the flat panel display is obviously much smaller than the original error E_{ORI} (fs, Gray), and the brightness error look up table definitely produces an excellent correction and compensation effect to the brightness error caused by the sustain frequency. Therefore, the second preferred embodiment can produce a brightness error compensation circuit 41 according to the brightness error look up table as shown in FIG. 5 to operate with a prior art error diffusion compensation circuit 40. Before the error diffusion compensation circuit 40 uses the error diffusion method to compensate the input gray levels, the brightness error compensation circuit 41 corrects the signals inputted to the flat panel display in advance, so as to overcome the gray level error as well as the error between the actual output brightness and the ideal output brightness of the flat panel display.

The third preferred embodiment of the present invention bases on the first and second preferred embodiments of the invention to measure the actual output brightness value Yₘₑₐ (fs, Gray) and the ideal output brightness value Y_{ideal} (fs, Gray) to create a brightness to gray look up table and a brightness error look up table respectively as shown in Table 5, wherein the first converted gray level LUT_{BG} (fs, Gray) in the brightness to gray look up table maps the original input gray level to a corresponding brightness closest to the ideal output brightness Y_{BG} (fs, Gray), and the brightness error E_{BG} between the output brightness Y_{BG} (fs, Gray) and the ideal output brightness Y_{ideal} (fs, Gray) can be calculated according to the following formula:
E_{BG}(fs, Gray)=Y_{ideal}(fs, Gray)−Y_{BG}(fs, Gray)

TABLE 5

| Input | Ideal | Original | | Brightness to Gray LUT | | | Brightness Error LUT | | |
|---|---|---|---|---|---|---|---|---|---|
| Gray | Y_{ideal} | Yₘₑₐ | E_{ORI} | LUT_{BG} | Y_{BG} | E_{BG} | LUT_{BE} | Y_{BE} | E_{BE} |
| (g) | (f, g) | (f, g) | (f, g) | (f, g) | (f, g) | (f, g) | (f, g) | (f, g) | (f, g) |
| (unit) | (cd/m²) | (cd/m²) | (cd/m²) | (gray) | (cd/m²) | (cd/m²) | (gray) | (cd/m²) | (cd/m²) |
| 0 | 0.00 | 0.00 | 0.00 | 0 | 0.00 | 0.00 | 0.00 | 0.00 | 0.00 |
| 1 | 0.75 | 0.00 | 0.75 | 2 | 0.57 | 0.18 | 0.17 | 0.70 | 0.05 |
| 2 | 1.50 | 0.57 | 0.93 | 3 | 1.62 | −0.12 | −0.11 | 1.45 | 0.05 |
| 3 | 2.25 | 1.62 | 0.63 | 4 | 2.18 | 0.07 | 0.06 | 2.20 | 0.05 |
| 4 | 3.00 | 2.18 | 0.82 | 5 | 3.26 | −0.26 | −0.24 | 2.98 | 0.02 |
| 5 | 3.75 | 3.26 | 0.49 | 6 | 3.83 | −0.08 | −0.14 | 3.73 | 0.02 |
| 6 | 4.50 | 3.83 | 0.67 | 7 | 4.85 | −0.35 | −0.35 | 4.49 | 0.01 |
| 7 | 5.25 | 4.85 | 0.40 | 8 | 5.42 | −0.17 | −0.30 | 5.19 | 0.06 |
| 8 | 6.00 | 5.42 | 0.58 | 9 | 6.47 | −0.47 | −0.45 | 5.89 | 0.11 |
| 9 | 6.75 | 6.47 | 0.28 | 9 | 6.47 | 0.28 | 0.41 | 6.72 | 0.03 |
| 10 | 7.50 | 7.15 | 0.35 | 10 | 7.15 | 0.35 | 0.27 | 7.44 | 0.06 |
| 11 | 8.25 | 7.93 | 0.32 | 12 | 8.47 | −0.22 | −0.16 | 8.25 | 0.00 |
| 12 | 9.00 | 8.47 | 0.53 | 13 | 9.01 | −0.01 | −0.01 | 8.95 | 0.05 |
| 13 | 9.75 | 9.01 | 0.74 | 14 | 9.57 | 0.18 | 0.18 | 9.72 | 0.03 |
| 14 | 10.50 | 9.57 | 0.93 | 15 | 10.57 | −0.07 | −0.07 | 10.45 | 0.05 |
| 15 | 11.25 | 10.57 | 0.68 | 16 | 11.14 | 0.11 | 0.15 | 11.25 | −0.00 |
| 16 | 12.00 | 11.14 | 0.86 | 17 | 11.92 | 0.08 | 0.08 | 12.03 | −0.03 |
| 17 | 12.75 | 11.92 | 0.83 | 18 | 12.94 | −0.19 | −0.19 | 12.71 | 0.04 |
| 18 | 13.50 | 12.94 | 0.56 | 18 | 12.94 | 0.56 | 0.38 | 13.48 | 0.02 |
| 19 | 14.25 | 14.43 | −0.18 | 19 | 14.43 | −0.18 | −0.12 | 14.26 | −0.01 |
| 20 | 15.00 | 15.00 | 0.00 | 20 | 15.00 | 0.00 | 0.00 | 15.00 | 0.00 |

The brightness error look up table includes a second converted gray level equal to the original input gray level plus the brightness error compensation value LUT_{BE} (fs, Gray) as given below:

$$if {Y}_{ideal} ( f , g ) \geq {Y}_{BG} ( f , g )$$

$${LUT}_{BE} ( f , g ) = \frac{{Y}_{ideal} ( f , g ) - {Y}_{BG} ( f , g )}{{Y}_{BG} ( f , g + 1 ) - {Y}_{BG} ( f , g )}$$

$$if {Y}_{ideal} ( f , g ) < {Y}_{BG} ( f , g )$$

$${LUT}_{BE} ( f , g ) = \frac{{Y}_{ideal} ( f , g ) - {Y}_{mea .} ( f , g )}{{Y}_{BG} ( f , g ) - {Y}_{BG} ( f , g - 1 )}$$

After the second converted gray level is inputted to the flat panel display, the flat panel display will output a brightness close to the ideal output brightness Y_{BE} (fs, Gray), and the brightness error E_{BE} between the output brightness Y_{BE} (fs, Gray) and the ideal output brightness Y_{ideal} (fs, Gray) can be calculated according to the following formula:
E_{BE}(fs, Gray)=Y_{ideal}(fs, Gray)−Y_{BE}(fs, Gray)

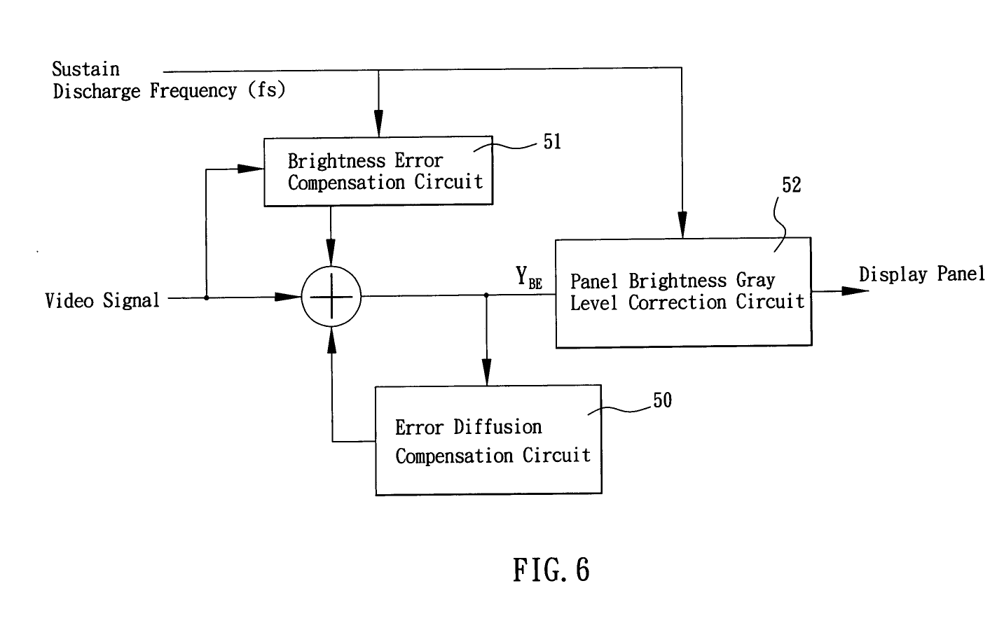

From Table 5, after the gray levels inputted to the flat panel display are corrected by the brightness to gray look up table and the brightness error look up table, the error E_{BE} (fs, Gray) between the actual output brightness and the ideal output brightness of the flat panel display is much smaller than the original error E_{ORI} (fs, Gray) and the error after brightness to gray LUT E_{BG} (fs, Gray), and thus the correction and compensation of the brightness error produce a certain effect. The third preferred embodiment can use the brightness to gray look up table and the brightness error look up table to produce a panel brightness gray level correction circuit 52 and a brightness error compensation circuit 51 as shown in FIG. 6 to operate with a prior art error diffusion compensation circuit 50. Therefore, before the error diffusion compensation circuit 50 can compensate the input gray level by using an error diffusion method, and the brightness error compensation circuit 51 can correct the signals inputted to the flat panel display in advance. After the error diffusion compensation circuit 50 compensates the input gray level, the panel brightness gray level correction circuit 52 corrects the signals inputted to the flat panel display to overcome the gray level error as well as the error between the actual A output brightness and the ideal output brightness of the flat panel display.

It is worthy to note that the first, second, and third preferred embodiments of the present invention are adopted for overcoming the foregoing error, but these preferred embodiments are not intended for limiting the hardware circuits, and those skilled in the arts can accomplish the same purpose by software according to the foregoing design concept of the invention. In addition, the invention is not limited to be used for plasma display panels only. For any flat panel display having an unexpected result on the proportional relation between the gray level and the brightness of the flat panel display, the method disclosed in the foregoing preferred embodiments can be used, and the actual measured output brightness and the calculated ideal output brightness of the flat panel display can be used to create a look up table. Before a gray level is inputted to the flat panel display, the look up table is used to find a corresponding converted gray level, and the brightness error compensation gray level value corresponding to the converted gray level will be inputted to the flat panel display to allow the flat panel display to output a gray level brightness closest to the ideal output brightness Y_{ideal} (fs, Gray), and all of the above are intended to be covered in the patent claims of this invention.

While the invention herein disclosed has been described by means of specific embodiments, numerous modifications and variations could be made thereto by those skilled in the art without departing from the scope and spirit of the invention set forth in the claims.

What is claimed is:

1. A method for compensating a brightness error of a flat panel display, comprising:
inputting a series of gray level signals (Gray) to a flat panel display under a fixed sustain frequency (fs), and measuring an output brightness of said flat panel display to obtain an actual output brightness Yₘₑₐ (fs Gray);
calculating an ideal output brightness Y_{ideal} (fs, Gray) corresponding to said gray level according to the linear proportional relation between said input gray level and said ideal output brightness;
creating a look up table according to said actual output brightness Yₘₑₐ (fs Gray) and said ideal output brightness Y_{ideal} (fs, Gray), and said look up table comprises a series of converted gray levels (Gray′) and actual output brightness Yₘₑₐ (fs Gray′) corresponding to each of said converted gray levels, and said actual output brightness Yₘₑₐ (fs, Gray′) corresponding to said each converted gray level is closest to said ideal output brightness Y_{ideal} (fs, Gray) of said each input gray level, such that when a gray level is going to be inputted to said flat panel display, said look up table will be used to look up a corresponding converted gray level according to said gray level in advance and said converted gray level will be inputted to said flat panel display, so as to allow said flat panel display to output a gray level brightness closest to said ideal output brightness Y_{ideal} (fs, Gray).

2. A method for compensating a brightness error of a flat panel display, comprising:
using an error diffusion compensation circuit to compensate a gray level under a fixed sustain frequency by an error diffusion method, and measuring an output brightness to obtain an actual output brightness Yₘₑₐ (fs, Gray) after said compensated gray level is inputted to said flat panel display;
calculating an ideal output brightness Y_{ideal} (fs, Gray) corresponding to said input gray levels according to the linear proportional relation between said input gray level and said ideal output brightness;
creating a look up table according to said actual output brightness Yₘₑₐ (fs, Gray) and said ideal output brightness Y_{ideal} (fs, Gray), and said look up table comprises a series of converted gray levels (Gray′) and actual output brightness Yₘₑₐ (fs, Gray′) corresponding to each of said converted gray levels, and said actual output brightness Yₘₑₐ (fs, Gray′) corresponding to said each converted gray level is closest to said ideal output brightness Y_{ideal} (fs, Gray) corresponding to said each input gray level, such that when a gray level is going to be inputted to said flat panel display, said look up table will be used to look up a corresponding converted gray level according to said gray level in advance, and said converted gray level will be inputted to said flat panel display, so as to allow said flat panel display to output a gray level brightness closest to said ideal output brightness Y_{ideal} (fs, Gray).

3. A method for compensating a brightness error of a flat panel display, comprising:
using an error diffusion compensation circuit to compensate a gray level under a fixed sustain frequency by an error diffusion method, and measuring an output brightness to obtain an actual output brightness Yₘₑₐ (fs, Gray) after said compensated gray level is inputted to said flat panel display;
calculating an ideal output brightness Y_{ideal} (fs, Gray) corresponding to said input gray levels according to the linear proportional relation between said input gray level and said ideal output brightness;
creating a brightness to gray look up table according to said actual output brightness Yₘₑₐ (fs, Gray) and said ideal output brightness Y_{ideal} (fs, Gray), and said brightness to gray look up table comprises a series of first converted gray level LUT_{BG} (fs, Gray) and actual output brightness Yₘₑₐ (fs, Gray′) corresponding to each of said converted gray levels, and said actual output brightness Yₘₑₐ (fs, Gray′) corresponding to said each converted gray level is closest to said ideal output brightness Y_{ideal} (fs, Gray) corresponding to said each input gray level, such that when a gray level is going to be inputted to said flat panel display, said brightness to gray look up table will be used to look up a corresponding first converted gray level LUT_{BG} (fs, Gray) according to said gray level in advance, and said first converted gray level LUT_{BG} (fs, Gray) will be inputted to said flat panel display, so as to allow said flat panel display to output a gray level brightness closest to said ideal output brightness Y_{ideal} (fs, Gray).

4. The method of claim 3, further comprising:
using said actual output brightness Yₘₑₐ (fs Gray) as a base to interpolate and calculate a brightness error compensation value LUT_{BE} (fs, Gray) required for said ideal output brightness Y_{ideal} (fs, Gray) according to the following formula, provided that the frequency at the time is fs=f, and the gray level value is Gray=g:
$$if {Y}_{ideal} ( f , g ) \geq {Y}_{mea .} ( f , g )$$
$${LUT}_{BE} ( f , g ) = \frac{{Y}_{ideal} ( f , g ) - {Y}_{mea .} ( f , g )}{{Y}_{mea .} ( f , g + 1 ) - {Y}_{mea .} ( f , g )}$$
$$if {Y}_{ideal} ( f , g ) < {Y}_{mea .} ( f , g )$$
$${LUT}_{BE} ( f , g ) = \frac{{Y}_{ideal} ( f , g ) - {Y}_{mea .} ( f , g )}{{Y}_{mea .} ( f , g ) - {Y}_{mea .} ( f , g - 1 )} ;$$
and
creating a brightness error look up table, such that when a gray level is going to inputted to said flat panel display, said brightness error look up table will be used to look up a corresponding brightness error compensation LUT_{BE} (fs, Gray) according to said gray level in advance, and said input gray level plus said brightness error compensation value LUT_{BE} (fs, Gray) will be used to obtain a second converted gray level value; and after said second converted gray level value is inputted to said flat panel display, said flat panel display outputs a brightness close to an ideal output brightness Y_{BE} (fs, Gray).

5. A method for compensating a brightness error of a flat panel display, comprising:
using an error diffusion compensation circuit to compensate a gray level under a fixed sustain frequency by an error diffusion method, and measuring an output brightness to obtain an actual output brightness Yₘₑₐ (fs, Gray) after said compensated gray level is inputted to said flat panel display;
calculating an ideal output brightness Y_{ideal} (fs, Gray) corresponding to said input gray levels according to the linear proportional relation between said input gray level and said ideal output brightness;
using said actual output brightness Yₘₑₐ (fs, Gray) as a base to interpolate and calculate a brightness error compensation value LUT_{BE} (fs, Gray) required for said ideal output brightness Y_{ideal} (fs, Gray) according to the following formula, provided that the frequency at the time is fs=f, and the gray level value is Gray=g:
$$if {Y}_{ideal} ( f , g ) \geq {Y}_{mea .} ( f , g )$$
$${LUT}_{BE} ( f , g ) = \frac{{Y}_{ideal} ( f , g ) - {Y}_{mea .} ( f , g )}{{Y}_{mea .} ( f , g + 1 ) - {Y}_{mea .} ( f , g )}$$
$$if {Y}_{ideal} ( f , g ) < {Y}_{mea .} ( f , g )$$
$${LUT}_{BE} ( f , g ) = \frac{{Y}_{ideal} ( f , g ) - {Y}_{mea .} ( f , g )}{{Y}_{mea .} ( f , g ) - {Y}_{mea .} ( f , g - 1 )} ;$$
and
creating a brightness error look up table (Brightness Error LUT), such that when a gray level is going to be inputted to said flat panel display, said brightness error look up table will be used to look up a corresponding brightness error compensation LUT_{BE} (fs, Gray) according to said gray level in advance, and said input gray level plus said brightness error compensation value LUT_{BE} (fs, Gray) will be used to obtain a second converted gray level value; and after said second converted gray level value is inputted to said flat panel display, said flat panel display outputs a brightness close to an ideal output brightness Y_{BE} (fs, Gray).

6. A method for compensating a brightness error of a flat panel display, comprising:
inputting a series of gray level signals (Gray) to a flat panel display under a fixed sustain frequency (fs), and measuring an output brightness of said flat panel display to obtain an actual output brightness Yₘₑₐ (fs Gray); calculating an ideal output brightness Y_{ideal} (fs, Gray) corresponding to said gray level according to the linear proportional relation between said input gray level and said ideal output brightness;
using said actual output brightness Yₘₑₐ (fs, Gray) as a base to interpolate and calculate a brightness error compensation value LUT_{BE} (fs, Gray) required for said ideal output brightness Y_{ideal} (fs, Gray) according to the following formula, provided that the frequency at the time is fs=f, and the gray level value is Gray=g:
$$if {Y}_{ideal} ( f , g ) \geq {Y}_{mea .} ( f , g )$$
$${LUT}_{BE} ( f , g ) = \frac{{Y}_{ideal} ( f , g ) - {Y}_{mea .} ( f , g )}{{Y}_{mea .} ( f , g + 1 ) - {Y}_{mea .} ( f , g )}$$
$$if {Y}_{ideal} ( f , g ) < {Y}_{mea .} ( f , g )$$
$${LUT}_{BE} ( f , g ) = \frac{{Y}_{ideal} ( f , g ) - {Y}_{mea .} ( f , g )}{{Y}_{mea .} ( f , g ) - {Y}_{mea .} ( f , g - 1 )} ;$$
and
creating a brightness error look up table, such that when a gray level is going to be inputted to said flat panel display, said brightness error look up table will be used to look up a corresponding brightness error compensation LUT_{BE} (fs, Gray) according to said gray level in advance, and said input gray level plus said brightness error compensation value LUT_{BE} (fs, Gray) will be used to obtain a second converted gray level value; and after said second converted gray level value is inputted to said flat panel display, said flat panel display outputs a brightness close to an ideal output brightness Y_{BE} (fs, Gray).
